(19) United States
(12) Patent Application Publication
(10) Pub. No.: US 2026/0215884 A1
(43) Pub. Date: Jul. 30, 2026

(54) COMBINED ALIGNER AND DIRECT BONDING WIRE SYSTEM AND METHOD

(71) Applicant: Alta Smiles, Inc., Fort Washington, PA (US)

(72) Inventors: Gary D. GIEGERICH, Fort Washington, PA (US); Amanda M. FRANKS, Fort Washington, PA (US); Benjamin CASSALIA, Fort Washington, PA (US)

(21) Appl. No.: 19/142,498

(22) PCT Filed: Dec. 21, 2023
(86) PCT No.: PCT/US2023/085354

§ 371 Date: Jun. 23, 2025

Related U.S. Application Data
(60) Provisional application No. 63/434,998, filed on Dec. 23, 2022.

(51) Int. Cl. A61C 7/08; A61C 7/20

(52) U.S. Cl. CPC A61C 7/08; A61C 7/20

(57) ABSTRACT

A system for orthodontic treatment of a patient's teeth wherein a non-tracking tooth is not moving in accordance with an aligner treatment plan including a wire having a first end and a second end, a bonding material configured to secure the first end to one of the patient's teeth and a corrective aligner having a lingual wall and a facial wall. A relief window is formed in the lingual wall. The relief window provides space to accommodate the wire secured to the patient's teeth.

### CROSS-REFERENCE TO RELATED APPLICATION

The present application claims the benefit of U.S. Provisional Patent Application No. 63/434,998; filed on Dec. 23, 2022 and each titled “Combined Aligner and Direct Bonding Wire System and Method” the entire contents of which is incorporated herein by reference in its entirety.

### BACKGROUND OF THE INVENTION

Orthodontic aligners are designed to move teeth a little at a time without using traditional braces including brackets that are bonded to the patient's teeth, wires connecting the brackets, elastic bands that apply pressure between brackets and related hardware and appliances. The orthodontic aligners are typically plastic outlines, molds, near replicas or coverings of a patient's teeth that are designed to apply pressure to the patient's teeth. The aligners preferably move the patient's teeth over a period of time to align the teeth in a preferred orientation and are comprised of a series of aligners that are worn in series to gradually move the patient's teeth to a final aligned position based on an original aligner treatment plan. Wearing the series aligners applies gentle pressure on the teeth, ever-so-slightly repositioning them. The aligners are often clear and are less conspicuous than traditional brackets and wires. The orthodontic aligners are typically provided as the series of aligners by the orthodontic professional based on the original aligner treatment plan. The aligner treatment plan is designed to move the current configuration of the patient's teeth to a target orientation or configuration of the patient's teeth where the teeth are in a preferred alignment. The aligner treatment plan is designed to occur over a period of time by sequentially applying the series of aligners to the patient's teeth to move the teeth from the current configuration to the target orientation or configuration.

In practice, certain of the patient's teeth often do not track to the prescribed original aligner treatment plan, while other of the patient's teeth track to the aligner treatment plan, as expected. These non-tracking teeth or a non-tracking tooth are generally not moving as anticipated by the original aligner treatment plan, such as not moving to a particular location on the patient's arches or relative to adjacent teeth or not pivoting or rotating to a desired orientation relative to an axis of the tooth or the patient's arches. These non-tracking teeth can slow the aligner treatment plan, requiring a patient to wear a particular aligner in the series of aligners longer than expected while most of the patient's teeth track to the plan or requiring destruction of pre-manufactured aligners along with manufacturing of a new series of aligners for a modified treatment plan to address the non-tracking teeth. It is desirable to design, develop and deploy a system and method for correcting the patient's teeth that do not track with the designed treatment plan to urge these non-tracking teeth back into the desired orientation and configuration of the treatment plan without requiring destruction of aligners designed for later stages of the treatment plan and potential delays in the patient's treatment. The present combined aligner and direct bonding wire system and method addresses teeth that are not tracking with the treatment plan to bring these non-tracking teeth back into the desired orientation and configuration of the treatment plan.

It would also be desirable to design, develop and deploy a system that permits a patient who is traditionally ineligible for treatment by aligners because of the positioning and misalignment of their teeth to utilize aligners based on a corrective treatment plan.

### BRIEF SUMMARY OF THE INVENTION

Briefly stated, the combined aligner and direct bonding wire system and method is directed to a system and procedure for using directly bonded wires in combination with aligners and/or a corrective aligner to improve and enhance aligner results. The directly bonded wires can be used for a non-tracking tooth or teeth that are not “tracking” properly with the aligner treatment plan, tooth movements that are insufficient under the aligner treatment plan, pre-treatment of teeth to bring them into compliance for traditional aligner treatment or a finishing procedure to enhance aligner outcomes. The directly bonded wires may be incorporated into treatments such that the directly bonded wires are used in conjunction with a corrective aligner that includes a cutout or relief window where the directly bonded wire is applied to the patient's teeth. The corrective aligner may be utilized during an initial treatment, after partial treatment when a non-tracking tooth is identified or in other scenarios where a tooth or teeth a not tracking or are significantly out of alignment compared to a remainder of the patient's teeth.

The preferred system and method may be employed when “tracking problems” are identified during orthodontic treatment of a patient's teeth with a series of aligners. Certain teeth may not track with the original aligner treatment plan when utilizing the series of aligners, which results in tracking problems for the specific tooth or a plurality of teeth. The system and method may then employ the corrective aligner and a directly bonded wire to move the non-tracking tooth relatively quickly, evaluate the teeth for tight contacts and continue with the series of aligners from the original aligner treatment plan during the evaluation process or following treatment by the corrective aligner and the directly bonded wire.

When a tooth is evaluated as having a tracking problem during treatment with the series of aligners, a medical/dental professional or the system may determine placement of wires to be directly bonded to the teeth to address the tracking problem. Determining the placement of wires may include determining optimal wire placement position—target tooth or teeth, and anchor tooth/teeth, Prowire option, which is a wire with a dissolvable coating that creates a tube in bonding material after bonding such that the wire may move in a controlled manner relative to the bonding in the mounted configuration. And positioning of the wires, determining wire selection—material and gauge (length also may be recommended), determining optimal timing of wire placement—during which current or future tray(s), determining whether any interproximal reduction (“IPR”) is needed—if so specific directions and reviewing the original aligner treatment plan. The directly bonded wire determination and placement of wires may include bonding a wire directly to two adjacent teeth, bonding a wire across a plurality of teeth, bonding a wire at its ends to two spaced teeth and movably securing the wire to teeth between the two spaced teeth such that the wire is movable relative to the intermediate teeth or related bonding and wire placement strategies. These directly bonded wires may be bonded or movably secured facially or lingually to the patient's teeth. In the preferred process, the clinician or the system or central processor determines timing to apply directly bonded wire(s) or “C5 wires” to the patient's teeth during the aligner treatment plan while the patient continues to wear the aligners and/or may suggest or provide instructions/plans, and possibly a device, instruments and equipment, for creating apertures or relief windows in aligner(s) so that tray(s) can be worn during the wire treatment period, particularly where the relief windows in the corrective aligner(s) are positioned where the direct bonding wire is bonded to the teeth that are not tracking with the original aligner treatment plan. Trays or aligners already made for the original aligner treatment plan may be cut or new trays or corrective aligners with the apertures or relief windows may be constructed for application to the patient's teeth. Instructions may include drawings, a template, textual instructions, videos or other mechanisms or systems for defining the relief windows in the aligners.

During the preferred process, once the tooth that is not tracking as expected or has not moved to the satisfaction of clinician, activation wires or directly bonded wires may be mounted to the patient's teeth to urge the non-tracking teeth into the preferred orientation and location of the original aligner treatment plan based on a corrective treatment plan that utilizes the wires and the corrective aligner. Stabilization wires may also be utilized to maintain the position or tracking of certain of the patient's teeth. Use of the wire activations may further be executed post aligner therapy or following the full aligner treatment plan with appropriate apertures or spaces placed in removable retention devices. The patient may also wear a Hawley retainer following the conclusion of the treatment plan. The wires and a pre-treatment or corrective aligner may further be utilized to shift the patient's teeth into a configuration where the patient is eligible for aligner treatment where the patient's tooth configuration would traditionally disqualify them from treatment with aligners.

Wire positioning guides may be provided to the clinician to facilitate positioning of the direct bonding wire on the patient's teeth such that the directly bonded wire is positioned in the relief window when the aligner and the directly bonded wire are utilized concurrently. The wire positioning guides may be comprised of a mark on the patient's teeth, a template for placing markings on the patient's teeth, a template for positioning on the patient's teeth and directing positioning of the wire, a physical guide placed on the tooth to ensure proper placement and ease of placement of the wire, a video directing placement, markings on the aligner proximate the relief window indicating proper placement or nearly any system or method that directs the clinician regarding desired positioning of the wire relative to the patient's teeth.

Utilizing the directly bonded wires alone or with the aligners and the corrective aligner may decrease the number of anterior attachments required during an aligner treatment plan, decrease the number of aligners that are required during the aligner treatment plan, improve or decrease treatment times for the patients, increase patient satisfaction, reduce or eliminate the need for mid-case or mid-course corrections (re-treatment planning in the middle of a case, disposal of certain aligners in the series and manufacture of a new series of aligners) and other improvements that would be apparent to one having ordinary skill in the art based on a review of the present disclosure. Aligner companies frequently charge for mid-case or mid-course corrections and incorporating the aligners in combination with the directly bonded wires may reduce the number of mid-case corrections required during an aligner treatment plan. Facilitating mid-case corrections with the directly bonded wires may also prevent disposal of aligners that would no longer be useful in aligner cases where certain teeth are not tracking properly to the aligner treatment plan by accelerating movement of the non-tracking tooth into a position that complies with the original treatment plan. The series of aligners of the original aligner treatment plan may also be provided with a wire or wires and bonding material such that the patient or medical professional may develop and implement a corrective aligner treatment plan quickly, potentially without requiring construction of new corrective aligners or delivery of the wire and bonding material. The corrective aligner with relief window and directly bonded wire may also eliminate the time and effort wasted on making new aligners when a particular tooth or teeth are not tracking according to the original aligner treatment plan.

Briefly stated, the preferred invention is directed to a system for orthodontic treatment of a patient's teeth wherein a non-tracking tooth is not moving in accordance with an aligner treatment plan. The system includes a wire having a first end and a second end, a bonding material configured to secure the first end to one of the patient's teeth and an aligner having a lingual wall defining a lingual edge, a facial wall and a peak between the lingual and facial walls. A relief window is defined in the lingual wall. The relief window defines a relief edge having a first window end and a second window end. The relief edge is positioned closer to the peak than the first and second window ends. The relief window provides space to accommodate the wire secured to the patient's teeth in a mounted configuration.

In another aspect, the preferred invention is directed to a method for aligning a patient's teeth utilizing a system having a wire with a first end and a second end, a bonding material and a series of aligners including first and second aligners based on an original aligner treatment plan. The method includes the patient wearing the series of aligners or at least the first aligner on their teeth based on the original aligner treatment plan, identifying a non-tracking tooth after the patient wears the first aligner that is not tracking a desired movement of the non-tracking tooth based on the original aligner treatment plan, developing a corrective treatment plan to move the non-tracking tooth and securing the first end of the wire to the non-tracking tooth with the bonding material such that the second end of the wire is in facing engagement with another tooth of the patient's teeth. The corrective treatment plan including use of a corrective aligner(s) having a relief window, the wire and the bonding material. The method also includes the patient wearing the corrective aligner such that the wire is positioned adjacent to the relief window in the mounted configuration based on the corrective treatment plan.

### BRIEF DESCRIPTION OF THE SEVERAL VIEWS OF THE DRAWINGS

The foregoing summary, as well as the following detailed description of preferred embodiments of the combined aligners and directly bonded wires and method of the present disclosure, will be better understood when read in conjunction with the appended drawings. For the purposes of illustrating the combined aligner and direct bonding wire system and method, there are shown in the drawings preferred embodiments. It should be understood, however, that the application is not limited to the precise arrangements and instrumentalities shown. In the drawings:

FIG. 1 illustrates an upper occlusal view of a patient's teeth and/or arches with an instrument preparing a direct bonded wire for mounting to a lingual side of the patient's teeth, including to a non-tracking tooth;

FIG. 2 illustrates an upper occlusal view of the direct bonded wire of FIG. 1 secured at a first end to the non-tracking tooth and held against an adjacent tooth by orthodontic pliers and dental floss;

FIG. 3 illustrates an alternative upper occlusal view of the direct bonded wire of FIG. 2 secured at a first end to the non-tracking tooth;

FIG. 4 illustrates an upper occlusal view of the direct bonded wire of FIG. 2 wherein a cutting instrument is utilized to cut the direct bonded wire to define a second end;

FIG. 5 illustrates another upper occlusal view of the direct bonded wire of FIG. 2, wherein the second end of direct bonded wire of FIG. 4 is positioned against an adjacent tooth of the non-tracking tooth;

FIG. 6 illustrates an upper occlusal view of the direct bonded wire of FIG. 5, wherein a burr instrument is utilized to prepare the second end of the direct bonded wire;

FIG. 7 illustrates a top plan view of a dental aligner and a cutting instrument in accordance with a preferred embodiment of the system and method, wherein the cutting instrument is cutting a relief window into the dental aligner to accommodate the direct bonded wire of FIG. 6;

FIG. 8 illustrates an upper occlusal view of the direct bonded wire of FIG. 6 and the aligner of FIG. 7, wherein the relief window is aligned with the direct bonded wire of FIG. 6 and the wire is bonded at the first and second ends to the patient's teeth; and

FIG. 9 illustrates an upper occlusal view of the direct bonded wire of FIG. 6 following a predetermined amount of time after treatment with the direct bonded wire and the dental aligner wherein alignment of the previously non-tracking tooth has been improved.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right”, “left”, “lower” and “upper” designate directions in the drawings to which reference is made. The words “inwardly” or “distally” and “outwardly” or “proximally” refer to directions toward and away from, respectively, the patient's body, or the geometric center of the preferred combined aligner and direct bonding wire system and related parts thereof. The words, “anterior”, “posterior”, “superior,” “inferior”, “lateral” and related words and/or phrases designate preferred positions, directions and/or orientations in the human body to which reference is made and are not meant to be limiting. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

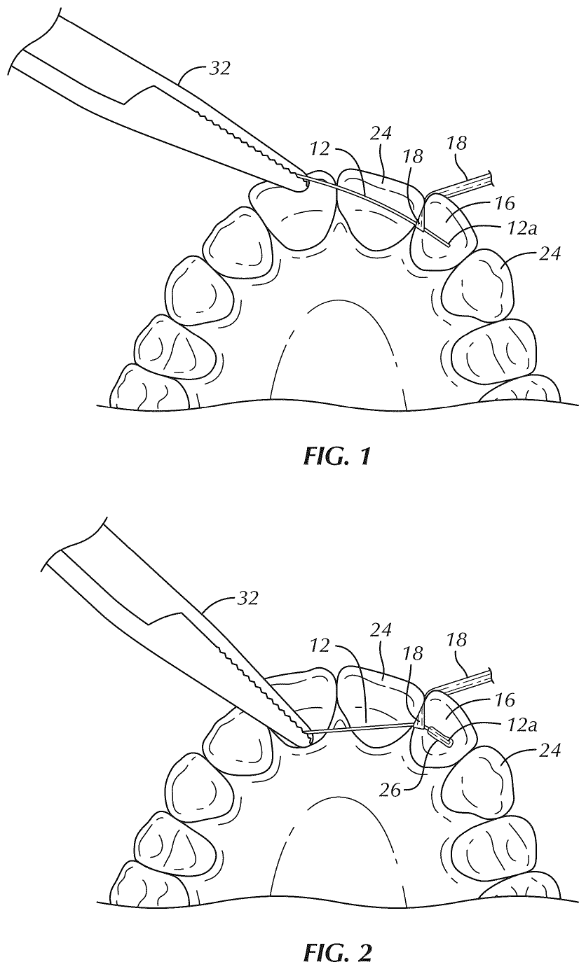

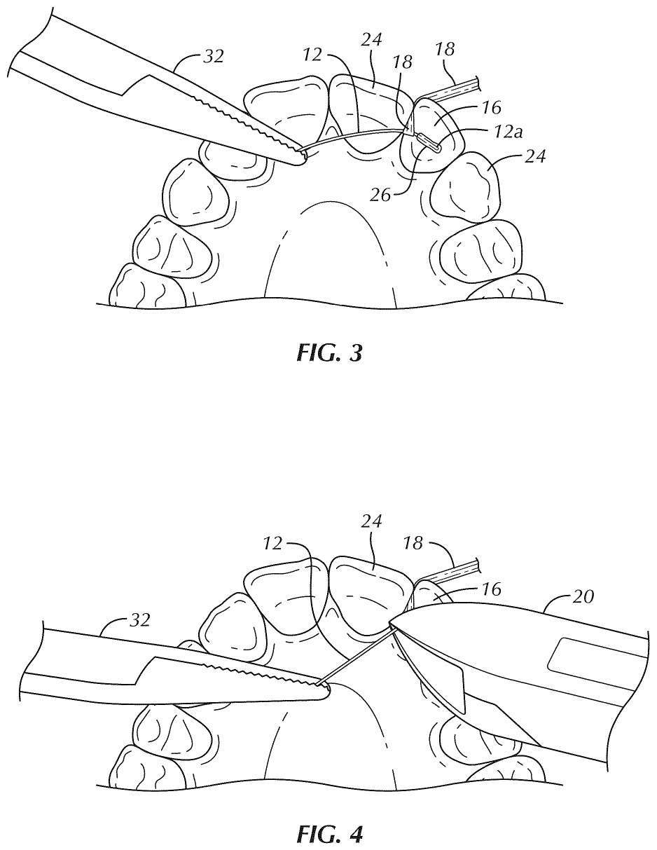

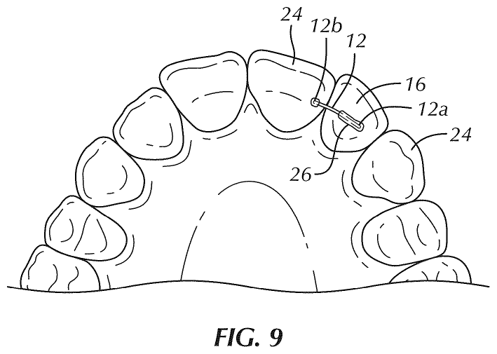

Referring to FIGS. 1-9, a combined aligner and direct bonding wire system and method preferably includes a direct bonding wire 12 having a first end 12a and a second end 12b and a corrective aligner 14 having a relief window 14a therein. The relief window 14a is aligned to accommodate the direct bonding wire 12 that is mounted to the patient's teeth in a mounted configuration (FIG. 8) to move a non-tracking tooth 16 into a position and orientation desired by the corrective treatment plan. The first end 12a of the wire 12 is preferably mounted to a non-tracking tooth 16 of the patient's teeth to bring the non-tracking tooth 16 back into a tracking position based on a treatment plan. The preferred system and method utilize the directly bonded wires 12 to improve and enhance aligner results or to make corrections to the non-tracking tooth 16 during the corrective aligner treatment plan. The directly bonded wires 12 and corrective aligner 14 can be used for teeth that are not “tracking” properly with the original aligner treatment plan, tooth movements that are insufficient under the aligner treatment plan, moving teeth into a position that will permit aligner treatment where these same teeth would traditionally disqualify a patient from aligner treatment or a finishing procedure to enhance aligner outcomes. The directly bonded wires 12 may be incorporated into treatments such that the directly bonded wires 12 are used in conjunction or combination with the corrective aligner 14 that includes the relief window or cutout 14a where the directly bonded wire 12 is applied to the patient's teeth, preferably to the non-tracking tooth 16 and an adjacent tooth 24 or multiple adjacent teeth and the corrective aligner 14 is worn by the user with the directly bonded wire 12 positioned adjacent to or within the relief window 14a in a mounted configuration.

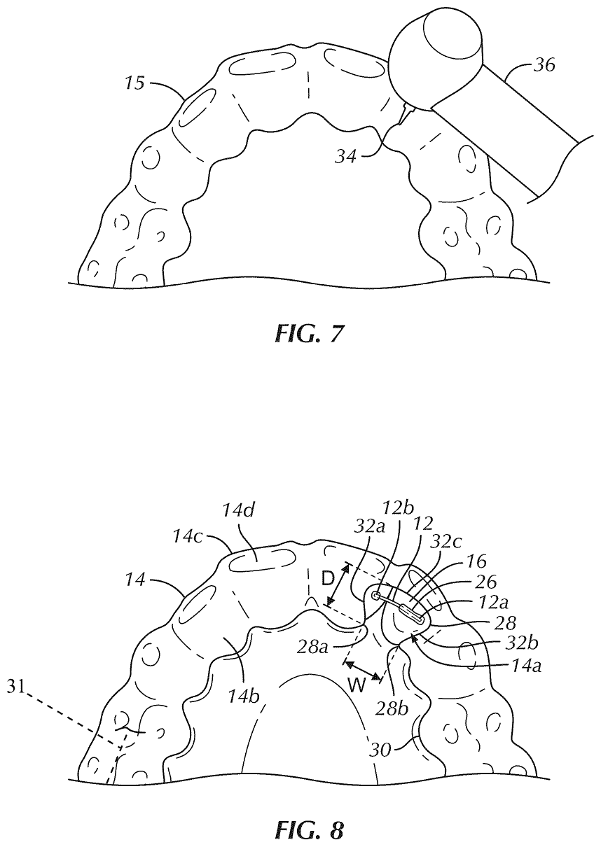

The corrective aligner 14 with the relief window 14a may be utilized after failure of an original aligner treatment plan when a non-tracking tooth is identified. The non-tracking tooth is not tracking to its expected movements of the aligner treatment plan and a corrective treatment plan, utilizing the corrective aligner 14 is developed. The original treatment plan typically utilizes a series of aligners 15 that are designed to be worn by the patient in series to gradually move the patient's teeth to a final alignment. The series of aligners 15 used in the original treatment plan are typically constructed when the original aligner treatment plan is developed and delivered to the patient or an orthodontic healthcare provider. An aligner 15 of the series of aligners 15 is shown in FIG. 7. Although the series of aligners 15 typically includes first, second and additional aligners 15, only a single aligner 15 is shown for simplicity, as the aligners 15 have a similar appearance to each other.

In the preferred embodiment, the directly bonded wires 12 are comprised of orthodontic shape memory wires 12, such as Nitinol shape memory wires, having various diameters or shapes to apply pressure and force on the patient's teeth to move the teeth. The directly bonded wires 12 are not limited to being comprised of orthodontic shape memory wires 12 and may be designed and configured as any hardware that is able to be connected to the patient's teeth to move the patient's teeth for orthodontic treatment and, preferably, for moving the non-tracking tooth 16 into a desired position and orientation of the aligner treatment plan or a corrective aligner treatment plan. The wires 12 exert pressure to effect tooth movements, preferably in combination with the corrective aligners 14 to urge non-tracking teeth 16 into the desired position and orientation of the treatment plan or the corrective treatment plan while the remainder of the teeth that are tracking with the original aligner treatment plan continue along the aligner treatment plan on the desired schedule.

The preferred system and method may be utilized without the cutout or relief window 14a or utilizing the original aligners 15, but such a configuration is not preferred, as combined use of the directly bonded wire 12 with the aligner 15 may cause the aligner 15 to be ill-fitting to the patient's teeth. Aligners 15 by their very natures are tightly fitting to apply pressure to the patient's teeth and the cutouts or relief windows 14a of the corrective aligners 14 are preferred to prevent interference between the corrective aligner 14 and the wire 12 when the wire 12 is bonded directly to the patient's teeth and the corrective aligner 14 is worn by the user in the mounted configuration. The wires 12 utilized in combination with the aligners 15 without the cutout or relief window 14a may not fit to the patient's teeth or could be dislodged from the patient's teeth or cause unwanted tooth movements because the combined use of the aligner 15 and directly bonded wire 12 don't fit properly to the patient's teeth.

Referring to FIGS. 2-6, the wire 12 may be provided having a relatively standard and oversized length. The wire 12 may be positioned relative to the patient's teeth, preferably adjacent to the non-tracking tooth 16, based on instructions provided by the clinician or the system. The placement may be guided by a template provided to the orthodontist or dental assistant that may be comprised of a chart, video guidance, hardware that positions the wire 12 in a desired location, markings on the patient's teeth, markings on the corrective aligner 14, preferably adjacent the relief window 14a or other systems or methods to direct the clinician regarding where the wire 12 should be placed on the patient's teeth. The wire 12 may be positioned on the lingual side of the patient's teeth by positioning the wire 12 with an orthodontic plier 32, wrapping a flexible cord or dental floss 18 around the wire 12, or utilizing another positioning implement such as an indirect bonding tray, urging the dental floss 18 through a gap between the non-tracking and adjacent teeth 16, 24 and applying pressure to urge the wire 12 against the lingual side of the teeth. The first end 12a of the wire 12 is then preferably bonded to a first tooth or non-tracking tooth 16 while the wire 12 is still held against the lingual side of the teeth. The wire 12 is then cut to a preferred length by a wire cutter 20 to define the second end 12b of the wire 12. The wire cutter 20 preferably provides an angled cut to the wire 12, although a ninety degree cut may also be employed. The second end 12b is preferably manipulated by a burr 22 to round off any rough edges for patient comfort and the second end 12b is preferably in facing engagement with the associated or adjacent tooth 24 to apply pressure and force to the teeth to facilitate alignment.

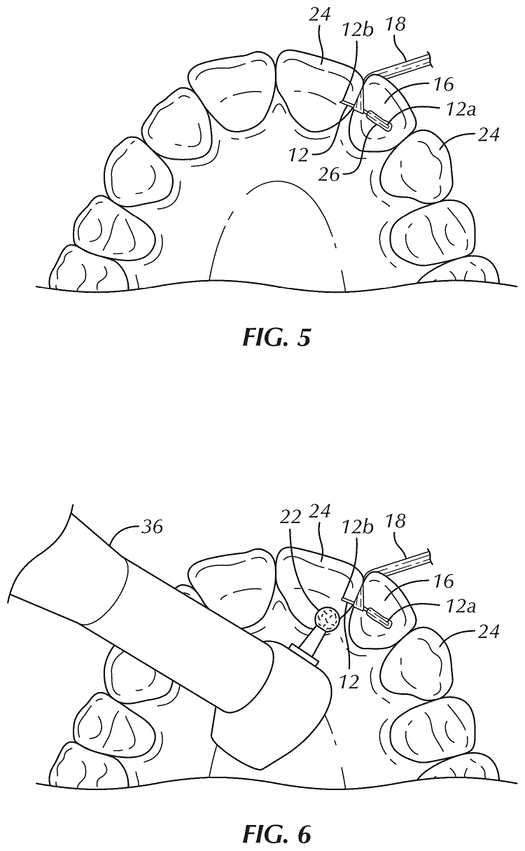

In the preferred embodiment shown in FIGS. 5, 6, 8 and 9, the wire 12 is relatively short spanning between two of the patient's teeth, including the non-tracking tooth 16 and the adjacent tooth 24, and is bonded to the non-tracking tooth 16 and positioned against the adjacent tooth 24 to apply force to the non-tracking and adjacent teeth 16, 24 to urge the non-tracking tooth 16 back into a preferred alignment, but is not so limited. The wire 12 may be provided to the clinician or patient in a U-shape, loop-shape, arc-shape, relatively straight or other shape that is adapted for mounting to the patient's teeth to move or manipulate the teeth for alignment purposes. The wire 12 is preferably applied and fixed to the teeth to exert forces on the teeth for alignment purposes. The wire 12 may be provided to the clinician or patient in a final size and shape that is mounted to the teeth at a prescribed location or may be provided having a standard or relatively large size that may be cut and configured by the clinician or patient to align the teeth. The wire 12 may be fixed to certain teeth, slidably connected to certain teeth, positioned against certain teeth to apply force or otherwise mounted or connected to the teeth to align the teeth or move the teeth to desired locations based on the treatment plan or the corrective treatment plan. For example, the wire 12 may be designed and configured for use with the orthodontic wire alignment system and method of U.S. Pat. No. 11,083,546, which is incorporated herein by reference in its entirety. The wire 12 may also be alternatively bonded to other teeth than the non-tracking tooth 16, such as the adjacent tooth 24, may be bonded to both the non-tracking and adjacent teeth 16, 24, bonded to two adjacent teeth 24 and in engagement with the non-tracking tooth 16 or otherwise positioned to urge the non-tracking tooth 16 or teeth into preferred orientations and/or positions. Any of the above-described wires 12 and related methods may be utilized in combination with the aligner 15 or the corrective aligner 14 with the relief window 14a, as is described herein.

A digital print-out or model of tooth movement may be developed as part of the aligner treatment plan and/or the corrective aligner treatment plan. The aligner treatment plan or the corrective aligner treatment plan may include a summary for each incremental tray and/or a digital display of the incremental tooth positions during the aligner treatment plan or the corrective aligner treatment plan. This positioning of each of the teeth during the treatment plan or the corrective treatment plan may be utilized to evaluate the optimal timing to place the directly bonded wires 12 to influence the desired movement if a tooth becomes a non-tracking tooth 16. In the preferred embodiment, since the wires 12 typically impact movements of the teeth more rapidly than the projected movements of the aligners 15 in accordance with the aligner treatment plan, the timing of placing the wire 12 on the non-tracking tooth 16 and adjacent teeth 24 may be designed to anticipate an appropriate time during the aligner treatment plan to utilize the wires 12 in combination with the corrective aligners 14 to bring the non-tracking tooth 16 back into compliance with the original aligner treatment plan. This updated planning may also consider inclusion of adequate space within the tooth recesses to accommodate the rapid movements of the non-tracking teeth 16.

For example, when considering a non-tracking tooth 16 during the original aligner treatment plan, the wires 12 typically move the non-tracking tooth 16 much faster than the aligners 15 and the health care provider preferably anticipates this much quicker movement of the teeth utilizing the wire 12. The health care provider typically detects the non-tracking tooth 16 by analyzing images of the arches and teeth during the aligner treatment plan and identifying the non-tracking teeth 16 or by comparing an incremental printout of movement of individual teeth in accordance with the treatment plan, such as a ClinCheck treatment plan and determining that the non-tracking tooth 16 is not progressing according to the incremental printout. The central processor may alternatively identify the non-tracking tooth 16 based on the model of the patient's teeth in comparison of scans or images of the teeth and transmit a notification to the dental professional that the non-tracking tooth 16 is out of compliance. The central processor or the dental professional may then develop the corrective aligner treatment plan to deploy the corrective aligner 14 and the wire 12 to urge the non-tracking tooth 16 back into a position and alignment in compliance with the original aligner treatment plan. When the non-tracking tooth 16 is identified, the health care provider or central processor may subsequently plan for utilization of the directly bonded wire 12 in combination with the corrective aligner 14 having the relief window 14a with the understanding that the directly bonded wire 12 will move the non-tracking tooth 16 more quickly than the aligner 15 and may time the utilization of the wire 12 to urge the non-tracking tooth 16 back into compliance with the original treatment plan.

In an alternative embodiment, the health care provider may place wires 12 in advance of an aligner treatment plan to effect certain, potentially difficult, tooth movement so that the aligner case progress more smoothly. This is particularly relevant for maxillary lateral incisors and mandibular canines. This pre-treatment plan use of the wires 12 can also be utilized to move teeth into a position where aligners 15 may be utilized to treat a patient's teeth where certain patients are considered ineligible for treatment by aligners 15 because of the positioning and orientation of the patient's teeth. The pre-treatment plan use of the wires 12 to prepare the patient's teeth for an aligner treatment plan may result in bringing the patient's teeth into a condition where they are eligible for aligner treatment where they would previously be considered ineligible. The advanced treatment of the patient's teeth may be used prior to starting an alignment treatment plan that could be difficult to treat with aligners 15 alone, to improve case acceptance, to speed up treatment and/or to reduce attachments that may be required during the aligner treatment plan without the use of the directly bonded wires 12. In addition, the corrective aligner 14 and wire 12 may be utilized as a pre-treatment to further speed up treatment for pre-alignment of the teeth and subsequent deployment of the aligner treatment plan using the series of aligners 15.

The preferred system may be provided or assembled as a kit for use by a dental or orthodontic professional for orthodontic treatment of the patient's teeth when the non-tracking tooth 16 is not moving in accordance with an aligner treatment plan or an original aligner treatment plan. The preferred system and kit includes the wire 12 having the first and second ends 12a, 12b, a bonding material 26 configured to secure the first end 12a to one of the patient's teeth and a corrective aligner 14 having a lingual wall 14b, a facial wall 14c and a peak 14d between the lingual and facial walls 14b, 14c. The peak 14d is positioned proximate biting surfaces of the teeth, the lingual wall 14b is positioned proximate a lingual surface of the teeth and the facial wall 14c is positioned proximate a facial surface of the teeth in a mounted configuration (FIG. 8). The lingual and facial walls 14b, 14c extend generally consistently or smoothly from the peak 14d to a lingual edge 30 or facial edge 31 such that the lingual and facial walls 14b, 14c are in proximity to or facial engagement with the lingual and facial surfaces of the patient's teeth. A portion of the facial edge 31 is shown in FIG. 8 and is shaped and configured for positioning proximate the patient's gum line in the mounted configuration. The relief window 14a is defined and formed in the lingual or facial walls 14b, 14c such that a window peak edge 32c is close to the lingual or facial surfaces of the patient's teeth, respectively. The window peak edge 32c, as well as first and second window sides 32a, 32b and the edge of the relief window 14a is generally positioned adjacent or in facing engagement with the surfaces of the patient's teeth such that the corrective aligner 14 applies forces to move the patient's teeth while the wire 12 is simultaneously applying forces to selected teeth 16, 24 for targeted movement. The corrective aligner 14 also preferably defines a lingual edge 30 spaced from the peak 14d and positioned closest to the patient's gums in the mounted configuration.

The relief window 14a may be defined in the lingual or facial walls 14b, 14c of the corrective aligner 14. In a first preferred embodiment, the relief window 14a is defined in the lingual wall 14b and defines a relief edge 28 having the first window end 28a and a second window end 28b. The relief edge 28 is positioned closer to the peak 14d than the first and second window ends 28a, 28b as the relief window 14a extends into the lingual or facial walls 14b, 14c toward the peak 14d to provide a space for securing or bonding the wire 12 to the patient's teeth on the lingual or facial surfaces in the mounted configuration. The relief window 14a provides space to accommodate the wire 12 secure to the patient's teeth in the mounted configuration. The relief edge 28 extends toward the peak 14d from the first and second window ends 28a, 28b to define the relief window 14a and provide space for bonding or securing the wire 12 to the patient's teeth by exposing the teeth in the mounted configuration such that the lingual or facial walls 14b, 14c do not block the surfaces of the teeth where the wire 12 is bonded or secured to the teeth. The first and second window ends 28a, 28b are not limited to being positioned at the lingual edge 30 of the corrective aligner 14 and may be positioned at the facial edge 31 of the corrective aligner 14, proximate the lingual edge 30 or the facial edge 31 of the corrective aligner 14 or nearly anywhere in the lingual or facial walls 14b, 14c of the corrective aligner 14 where the direction of edges of the relief window 14a changes. The relief window 14a is also not limited to including first and second window ends 28a, 28b, such as if the relief window 14a is round. The first and second window ends 28a, 28b are typically positioned at the lingual edge 30 or proximate the lingual edge 30 where the direction of the edge of the relief edge 28 changes within the lingual or facial walls 14b, 14c.

The wire 12 may be constructed of a Nitinol shape memory material but is not so limited and may be constructed of any material that may be formed into the generally shape of the wire 12, withstand the normal operating conditions of the wire 12 and perform the general functions of the wire 12, as described herein. The wire 12 may be constructed of a metallic material, a composite material or any material that is configured for bonding to the patient's teeth and applying forces to the teeth to move the teeth into a desired location and/or orientation, such as Nitinol, stainless steel, multistrand metallic materials, cobalt-chromium, nickel-titanium, copper nickel-titanium, shape memory metals, superelastic materials, beta titanium and other relatively strong, stiff and corrosion resistant materials.

The relief window 14a may be cut into the lingual or facial walls 14b, 14c of the corrective aligner 14, may be cut into both the lingual and facial walls 14b, 14c if multiple relief windows (not shown) are cut into the corrective aligner 14 or may be formed into the corrective aligner 14 when the corrective aligner 14 is manufactured. The corrective aligner 14 may be formed by direct printing the corrective aligner 14 based on the corrective treatment plan and a model developed based on scans of the patient's teeth. The relief window 14a may be positioned nearly anywhere on the corrective aligner 14 to provide relief and space for securing or bonding the wire 12 to the patient's teeth to move the teeth, preferably to move the non-tracking tooth 16 that is not tracking to the aligner treatment plan or the original aligner treatment plan. The original aligners 15 that are provided based on an original treatment plan may be modified into the corrective aligner 14 including the relief window 14a by cutting the relief window 14a into the original aligner 15, such as by using a cutting tool 34 with a dental handpiece 36 (FIG. 7). The modified aligner or corrective aligner 14 is worn by the patient with the relief window 14a exposing the portion of the patient's teeth where the wire 12 is bonded, mounted or secured, typically including exposure of at least portions of the non-tracking tooth 16.

The relief window 14a may define a window width W between the first and second window ends 28a, 28b and a window depth D. The relief window 14a is not limited to having the first and second window ends 28a, 28b that interrupt the lingual edge 30 and may be comprised of a hole in the lingual or facial walls 14b, 14c that does not interrupt the lingual edge 30 or the facial edge 31, as long as the relief window 14a exposes the surfaces of the teeth where the wire 12 is bonded or secured to the teeth in the mounted configuration. The preferred relief window 14a includes first and second window sides 32a, 32b and a window peak edge 32c proximate the peak 14d. The window depth D is defined between the first or second window end 28a, 28b and the window peak edge 32c. The relief window 14a is not limited to having the first and second window ends 28a, 28b, the first and second window sides 32a, 32b and the window peak edge 32c and may define a window diameter (not shown) in the lingual or facial walls 14b, 14c that exposes surfaces of the teeth for bonding or securing the wire 12 in the mounted configuration. The relief window 14a may be positioned in the lingual or facial walls 14b, 14c and may include the gap at the lingual or facial edge 30, 31 between the first and second window ends 28a, 28b. The window peak edge 32c is preferably positioned proximate the peak 14d, such as approximately mid-way between the lingual or facial edges 30, 30 and the peak 14d or closer to the peak 14d, as long as the relief window 14a may be positioned to accommodate bonding the wire 12 to the patient's teeth at the desired location.

The first end 12a of the wire 12 is configured for bonding to non-tracking tooth 16 and the second end 12b is configured for positioning against a surface of the adjacent tooth 24, which is adjacent to the non-tracking tooth 16. The first end 12a is not limited to being configured for bonding or securing to the non-tracking tooth 16 and may be configured for bonding to another tooth, such as the adjacent tooth 24 or may be molded into the corrective aligner 14 and extend into the relief window 14a to contact and move the tooth that is exposed in the relief window 14a for moving this tooth, which is preferably the non-tracking tooth 16. In addition, the first end 12a may be bonded or secured to the adjacent tooth 24 or another tooth and configured to contact a surface of the non-tracking tooth 16 to move the non-tracking tooth 16 into a desired alignment relative to the other teeth or into a predetermined position. The wire 12 may be bonded to one of the patient's teeth such that the wire 12 is positioned adjacent to the relief window 14a and does not contact the corrective aligner 14 in the mounted configuration. The wire 12 may alternatively at least partially contact the corrective aligner 14 in the mounted configuration or be partially embedded into the corrective aligner 14 for moving the non-tracking tooth 16 into a desired alignment or position. The wire 12, however, is preferably positioned in the relief window 14a in the mounted configuration to facilitate fit of the corrective aligner 14 with the patient's teeth and accommodation of the wire 12 to apply forces to the teeth in the working configuration.

In the preferred embodiment, the relief window 14a has a generally parallelogram shape or a generally square shape with the first window side 32a, the second window side 32b and the window peak edge 32c to expose the surface of the teeth where the wire 12 is bonded or secured in the working configuration. The relief window 14a is not limited to having the parallelogram or square shape and may have nearly any shape that exposes the surfaces of the teeth where the wire 12 is bonded or secured without significantly impacting the structural integrity of the corrective aligner 14.

The flexible cord or dental floss 18 may be used to wrap around the wire 12 and extend through a gap between the non-tracking tooth 16 and the adjacent tooth 24 when securing the wire 12 to the non-tracking tooth 16. The flexible cord 18 may be comprised of multiple flexible cords 18 that extend through gaps between teeth to temporarily hold the wire 12 to the surface of the teeth to allow time for bonding the wire 12 to the teeth and to free the dental professional's hands to otherwise assist with treatment of the patient.

The kit of dental or orthodontic equipment may also include the burr 22 configured to prepare the second end 12b and the adjacent tooth 24 when securing the wire 12 to the non-tracking tooth 16. The burr 22 is driven by a dental handpiece to smooth the second end 12b and prepare the surface of the tooth for the procedure. The kit may be supplied to the user in a sterile package that is opened by the dental professional prior to the procedure. The sterile package may include the wire 12, the corrective aligner 14, the wire cutter 20, the burr 22 and the bonding material 26.

In operation, the system is used to align a patient's teeth utilizing the wire 12, the bonding material 26 and the corrective aligner 14. The system is preferably utilized to urge the teeth back into a position where the teeth are in compliance with an original aligner treatment plan that includes at least first and second aligners 15. The patient typically initiates the original aligner treatment plan utilizing the series of aligners 15 and the patient's teeth are not tracking in accordance with the original aligner treatment plan. The first and second aligners 15 are two aligners 15 in the series of aligners 15 of the original treatment plan, but not necessarily the first and second aligners that the patient wears in accordance with the original aligner treatment plan. For example, the patient may wear four aligners 15 of the series of aligners 15 in accordance with the original treatment plan and then wear the first aligner 15 when or before the non-tracking tooth 16 is identified. The preferred system and method are utilized when the patient's teeth are not tracking to the original aligner treatment plan. As a result of the non-tracking tooth 16, the corrective treatment plan is developed to address the non-tracking tooth 16. Alternatively, the non-tracking tooth 16 or non-tracking teeth may be identified prior to treatment, indicating that the patient is not a candidate for treatment using aligners 15 and the preferred system with the wire 12, bonding material 26 and corrective aligner 14 may be utilized to move the patient's teeth into a position and/or orientation where aligners 15 may be used to correct the alignment of the patient's teeth.

In the original aligner treatment plan, the patient is directed to wear the series of aligners 15 on their teeth. The preferred system and method are utilized when wearing the series of original aligners 15 results in movement of the patient's teeth that are not tracking with the original treatment plan. The non-tracking tooth 16 is identified after the patient wears the first aligner 15 and the non-tracking tooth 16 is not tracking a desired movement based on the original treatment plan. The corrective treatment plan is developed to move the non-tracking tooth 16 relatively quickly back into its anticipated position based on the original aligner treatment plan. The corrective treatment plan includes use of the corrective aligner 14 having the relief window 14, the wire 12 and the bonding material 26. The first end 12a of the wire 12 is preferably bonded to the non-tracking tooth 16 with the bonding material 26 as part of the corrective treatment plan such that the second end 12b of the wire 12 is in facing engagement and applies a force to another tooth of the patient's teeth. The corrective aligner 14 is worn such that the wire 12 is positioned adjacent to or in the relief window 14a in the mounted configuration to urge the non-tracking tooth 16 toward the preferred location and orientation. The wire 12 may be comprised of a Prowire or wire 12 that has a dissolvable coating. The wire 12 may be bonded to the patient's tooth at an intermediate position of the wire 12 such that the coating dissolves in the mounted configuration, thereby creating a channel or void in the bonding material 26 allowing the wire to move in a controlled manner relative to the tooth within the void. The directly bonded Prowire or coated wire 12 is typically configured for interaction with three of the patient's teeth, although the Prowire or coated wire 12 is not so limited and may be configured for interaction with two or more of the patient's teeth in the mounted configuration.

The relief window 14a is preferably defined in the lingual wall 14b of the corrective aligner 14 but may alternatively be defined in the facial wall 14c of the corrective aligner 14. The corrective aligner 14 may be formed by cutting the relief window 14a into the lingual or facial walls 14b, 14c of the second aligner of the original aligners 15, which was previously designed based on the original aligner treatment plan.

The method may also include the dental professional holding the wire 12 onto the lingual surface of the non-tracking tooth 16 by wrapping the flexible cord 18 around the wire 12, positioning a portion of the cord 18 in a gap between the non-tracking tooth 16 and the adjacent tooth 24 and applying a force on the flexible cord 18 through the gap away from the lingual surface to hold the wire 12 in place on the lingual surface of the teeth. The cord 18 may be held with a stopper engaging the cord 18 and the facial surface of the teeth to temporarily position the wire 12 on the teeth and free the dental professional's hands to further conduct the preferred method or procedure.

The second end 12b of the wire 12 may be prepared or smoothed by the burr 22 or another instrument for patient comfort when the wire 12 is bonded to the patient's teeth. The wire 12 is preferably position within or adjacent to the relief window 14a in the mounted configuration such that the wire 12 does not interfere with the positioning of the corrective aligner 14 on the patient's teeth. The method may also include providing instructions to the dental professional for marking the non-tracking tooth 16 to indicate a desired placement of the first end 14a on the non-tracking tooth 16.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

1. A system for orthodontic treatment of a patient's teeth, the system comprising:
a wire having a first end and a second end;
a bonding material configured to secure the first end to one of the patient's teeth, the second end being in facing engagement with another tooth of the patient's teeth and is slidably connected to the another tooth to apply force to the another tooth in a mounted configuration; and
a corrective aligner having a lingual wall defining a lingual edge, a facial wall and a peak between the lingual and facial walls, a relief window defined in the lingual or facial wall, the relief window defining a relief edge having a window peak edge, the window peak edge positioned proximate the peak, the relief window configured to provide space to accommodate the wire secured to the patient's teeth in the mounted configuration.

2. The system of claim 1, wherein the wire is constructed of a Nitinol shape memory material.

3. The system of claim 1, wherein the relief window is cut into the lingual wall.

4. The system of claim 1, wherein the relief window defines a window width between first and second window ends of the relief window and a window depth defined between the window peak edge and the relief edge proximate the lingual wall.

5. The system of claim 4, wherein the relief window includes first and second window sides, the window depth defined between one of the first and second window ends and the window peak edge.

6. The system of claim 1, wherein the first end is configured for bonding to a non-tracking tooth and the second end is configured for positioning against a surface of an adjacent tooth, the adjacent tooth being adjacent to the non-tracking tooth.

7. The system of claim 1, wherein the wire is bonded to one of the patient's teeth such that the wire is positioned adjacent to the relief window and does not contact the corrective aligner in the mounted configuration.

8. The system of claim 7, wherein the wire is positioned in the relief window in the mounted configuration.

9. The system of claim 1, wherein the relief window has a generally parallelogram shape.

10. The system of claim 9, wherein the relief window has a first window side, a second window side and a window peak edge, the first and second window sides and the window peak edge being arcuate.

11. The system of claim 1 further comprising:
a relatively thin flexible cord configured to wrap around the wire and extend through a gap between a non-tracking tooth and an adjacent tooth when securing the wire to the non-tracking tooth.

12. The system of claim 1, wherein the relief window defines a first window end and a second window end at the lingual edge.

13. A method for aligning a patient's teeth utilizing a system having a wire with a first end and a second end, a bonding material and a corrective aligner, wherein a patient is directed to wear a series of aligners including first and second aligners based on an original aligner treatment plan and movement of a non-tracking tooth of the patient's teeth is not tracking with the original aligner treatment plan, the method comprising:
identifying the non-tracking tooth after the patient wears the first aligner that is not tracking a desired movement of the non-tracking tooth based on the original aligner treatment plan;
developing a corrective treatment plan to move the non-tracking tooth, the corrective treatment plan including use of the corrective aligner having a relief window, the wire and the bonding material;
securing the first end of the wire to the non-tracking tooth with the bonding material such that the second end of the wire is in facing engagement with another tooth of the patient's teeth and is configured to apply force to the another tooth in a mounted configuration; and
positioning the corrective aligner on the patient's teeth such that the wire is positioned adjacent to the relief window in the mounted configuration.

14. The method of claim 13, wherein the relief window is defined in a lingual wall of the corrective aligner.

15. The method of claim 13, wherein the relief window is defined in a facial wall of the corrective aligner.

16. The method of claim 13, further comprising:
forming the corrective aligner by cutting the relief window into a lingual wall of the second aligner.

17. The method of claim 13, further comprising:
holding the wire onto a lingual surface of the non-tracking tooth by wrapping a flexible cord around the wire;
positioning a portion of the cord in a gap between the non-tracking tooth and an adjacent tooth of the patient's teeth; and
applying a force on the flexible cord through the gap away from the lingual surface to hold the wire on lingual surfaces of the non-tracking tooth and the adjacent tooth.

18. The method of claim 13, further comprising:
preparing the second end and a surface of an adjacent tooth for patient comfort.

19. The method of claim 13, wherein the wire is in the relief window in the mounted configuration.

20. The method of claim 13, further comprising:
marking the non-tracking tooth to indicate a desired placement of the first end on the non-tracking tooth.

21. The system of claim 1, wherein the wire in combination with the corrective aligner urge the one of the patient's teeth and the another tooth into a desired position and orientation of a treatment plan.

22. The method of claim 13, wherein the wire in combination with the corrective aligner urge the non-tracking tooth and the another tooth of the patient's teeth into a desired position and orientation of the corrective treatment plan.
